(19) United States
(12) Patent Application Publication
(10) Pub. No.: US 2025/0224234 A1
(43) Pub. Date: Jul. 10, 2025

(54) PEER-TO-PEER COMPASS

(71) Applicant: Totem Inc, Chattanooga, TN (US)

(72) Inventors: Chase Lemonds, Chattanooga, TN (US); Carter Fowler, Chattanooga, TN (US)

(73) Assignee: Totem Inc, Chattanooga, TN (US)

(21) Appl. No.: 19/009,457

(22) Filed: Jan. 3, 2025

Related U.S. Application Data
(60) Provisional application No. 63/560,307, filed on Mar. 1, 2024.
(60) Provisional application No. 63/617,589, filed on Jan. 4, 2024.

(51) Int. Cl. G01C 21/16; G01C 17/28; G01S 3/02

(52) U.S. Cl. CPC G01C 21/16; G01C 17/28; G01S 3/02

(57) ABSTRACT

A locator device system formed by a pair of locator devices that provide an illuminated display indicating a location of another locator device. Each locator device includes a case having an exterior with a front surface and a plurality of visual indicators. The visual indicators switch between illumination states and, when illuminated, are observable by observing the front surface of the case. A controller changes the illumination states based on a position of the other locator devices. A user interface receives user inputs including pairing input for pairing the locator devices to one another. When the locator devices are paired together and are located at a predefined location relative to one other, the controller changes a selected visual indicator located a direction corresponding to a direction heading towards the other one of the pair of locator devices from the first illumination state to the second illumination state.

### CROSS-REFERENCE TO RELATED APPLICATIONS

This application claims the benefit of U.S. Provisional Application No. 63/617,589 filed Jan. 4, 2024, and titled “PEER-TO-PEER DIGITAL COMPASS, and U.S. Provisional Application No. 63/560,307 filed Mar. 1, 2024, and titled “PEER-TO-PEER COMPASS,” the content of which is incorporated herein by reference in its entirety.

### FIELD

This invention relates generally to locators and tracking devices for real-time location reporting and providing a real-time directional bearing of peers.

### BACKGROUND

Tracking and locating peers can be of utmost importance in a variety of situations. Accordingly, various trackers or locator devices have been developed. For example, many cell phones are equipped with location sharing and tracking capabilities. However, many current locating devices require cellular service or Bluetooth paired to a cell phone. While this may be appropriate in some instances, in others, where cell service may be limited or keeping a phone charged is impracticable, other locators or trackers may be required. In addition, security concerns, i.e., who or what can track a user's location, are also present with current devices.

One scenario where tracking a peer's location is often necessary is at festivals, particularly outdoor festivals. Outdoor festivals, such as many music festivals, are often at large venues, fields, parks, etc., with multiple stages and many festival-goers often attend with a group of peers. Each peer in the group may be interested in seeing different acts or parts of the venue, meaning the group is likely to split up once inside the festival venue. While this may not be problematic in certain instances, attendance of certain festivals can reach into the hundreds of thousands. In such densely populated areas, cell service can be greatly diminished, particularly if large numbers of attendees are also attempting to utilize a cell phone-based tracking or locating device. Additionally, many current trackers require a specific application, which a user may or may not have on their phone. These festivals can also span multiple days while attendees remain located at the venue. As such, often, means to charge a phone are not available. Additionally, constantly removing a phone from a pocket or holding it in one's hand can become tiresome and increase the likelihood of the phone being damaged, lost, or stolen. In certain instances, a peer may not be able to be relied upon to monitor a phone screen or broadcast their location, such as if the peer becomes injured or otherwise incapacitated. Also, many of these festivals include water-elements or are held in harsh environments that can damage a cell phone or other conventional tracking device. Finally, the need or temptation to constantly look at a phone and a phone screen can diminish the festival experience for certain festival-goers.

What is needed, therefore, are devices, systems, and methods for locating a peer in real-time that can be utilized without use of a screen or the cellular network (i.e., utilizing a local network) and is reliable and operable in large, crowded environments like a music festival.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

### SUMMARY

The above and other problems are addressed by a locator device system having a pair of locator devices that are each configured to provide an illuminated display indicating a relative position or location of the other locator devices. Each locator device includes a case having an exterior that includes a front surface. Next, first visual indicators selectively change from a first illumination state to a second illumination state and, when illuminated, can be readily seen by observing the front surface of the case. The locator devices also include a controller for selectively changing first visual indicators between the first illumination state and the second illumination state in response to receiving location information identifying a relative position of the other locator devices. Next, a user interface located on the exterior of the case receives user inputs including pairing input for pairing the pair of locator devices to one another. In certain implementations, the user interface consists of a capacitive touch sensor creating a touch-zone on the front surface of the case, and all commands for controlling a powered-on locator device are provided to the locator device via the user interface. In some cases, the user interface includes a plurality of facets disposed on the front surface of the case. In such cases, each facet preferably corresponds to and covers a separate first visual indicator of the plurality of first visual indicators such that, when illuminated, the separate first visual indicators are each observable through only one of the facets.

When the locator devices are paired together and in response to receiving location information indicating that the pair of locator devices are at a predefined location relative to one other, the controller changes a selected visual indicator that is located in a direction corresponding to a direction heading towards the other one of the pair of locator devices from the first illumination state to the second illumination state. In certain implementations, the system includes a plurality of at least three locator devices that includes the pair of locator devices, and each is configured to be paired together and to indicate a direction of the other two of the at least three locator devices via the selected first visual indicator.

In certain implementations, the first visual indicators form a single ring of continuous lights that is located adjacent a perimeter of the case. In other cases, the first visual indicators are confined to within a central region of the case such that a space lacking first visual indicators extends from outside the central region to a perimeter of the case. In each case, the first visual indicators are configured to selectively illuminate and unilluminate. In certain implementations, second visual indicators form a single ring of lights located in the space lacking first visual indicators and are located adjacent a perimeter of the case. The second visual indicators are each configured to selectively illuminate and unilluminate.

In certain cases, the controller is configured to selectively change the first visual indicators between the first illumination state and the second illumination state in response to receiving location information indicating that the second one of the pair of locator devices is or is not within a first range relative to the first one of the pair of locator devices. Further, the controller is also preferably configured to selectively change the second visual indicators between the first illumination state and the second illumination state in response to receiving location information indicating that the second one of the pair of locator devices is or is not within a second and different range relative to the first one of the pair of locator devices. In certain cases, the second range lies entirely outside of the first range relative to the first one of the pair of locator devices such that the first range does not overlap with the second range.

In certain implementations, the first visual indicators comprise lights that are each configured to provide a variable illumination state depending on a location of the first one of the pair of locator devices relative to the second one of the pair of locator devices. In certain cases, the variable illumination state comprises a number of visual indicators that selectively illuminate, the number varying as a distance between the pair of locator devices increases and decreases. In certain cases, the variable illumination state comprises a steady illuminated state, a pulsing illuminated state, and a steady unilluminated state.

In certain cases, when the pair of locator devices are first separated by a distance that is less than a pre-defined maximum separation distance and are then separated by a distance that is greater than the pre-defined maximum separation distance, the selected first visual indicator remains in the second illumination state so as to indicate a last known position of the other one of the pair of locator devices. Preferably, the illumination status of the selected first visual indicator corresponding to the other one of the pair of locator devices is updated from the last known position only after the pair or locator devices are within the pre-defied maximum separation distance. In some cases, the first visual indicators include lights that are each configured to provide a variable brightness. In such cases, when the locator devices are separated by a distance that is greater than the pre-defined maximum separation distance, the selected first visual indicator is maintained at a minimum brightness level. On the other hand, when the pair of locator devices are separated by a distance that is less than the pre-defined maximum separation distance, the selected first visual indicator is maintained at a brightness level other than the minimum brightness level.

In certain implementations, the locator devices include an orientation sensor that senses an orientation of the case relative to a ground surface and communicates orientation signals to the controller that are based on the orientation of the case. In some cases, the orientation sensor is an inertial measurement unit. Preferably, each of the pair of locator devices is configured to, when the orientation sensor provides a first orientation signal to the controller, operate in a first illuminated mode of operation wherein at least one of the plurality of first visual indicators is configured to be illuminated in response to receiving the location information. Additionally, when the orientation sensor provides a second orientation signal to the controller, the locator devices operate in a second illuminated mode of operation wherein at least one of the plurality of first visual indicators is configured to be illuminated in response to an external input. In certain cases, the external input is an auditory input. Further, in some cases, in the second illuminated mode of operation, the number, selection, and/or position of the first visual indicators that are illuminated is dependent on a volume of the auditory input.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a front elevation view of a locator device according to an embodiment of the present invention;

FIG. 2 is a front perspective view of the locator device of FIG. 1;

FIG. 3A is a front exploded view depicting internal components of the locator device of FIG. 1;

FIG. 3B is a rear exploded view depicting internal components of the locator device of FIG. 1;

FIG. 4 is a representative diagram of an embodiment of an operational state of a system of locator devices according to certain embodiments of the present invention;

FIGS. 5A-5C are representative diagrams of an operational state of a system of locator devices according to an alternative embodiment of the present invention; and

FIGS. 6A-6C are top plan views of a group of locator devices in operative communication with each other according to an embodiment of the present invention.

### DETAILED DESCRIPTION

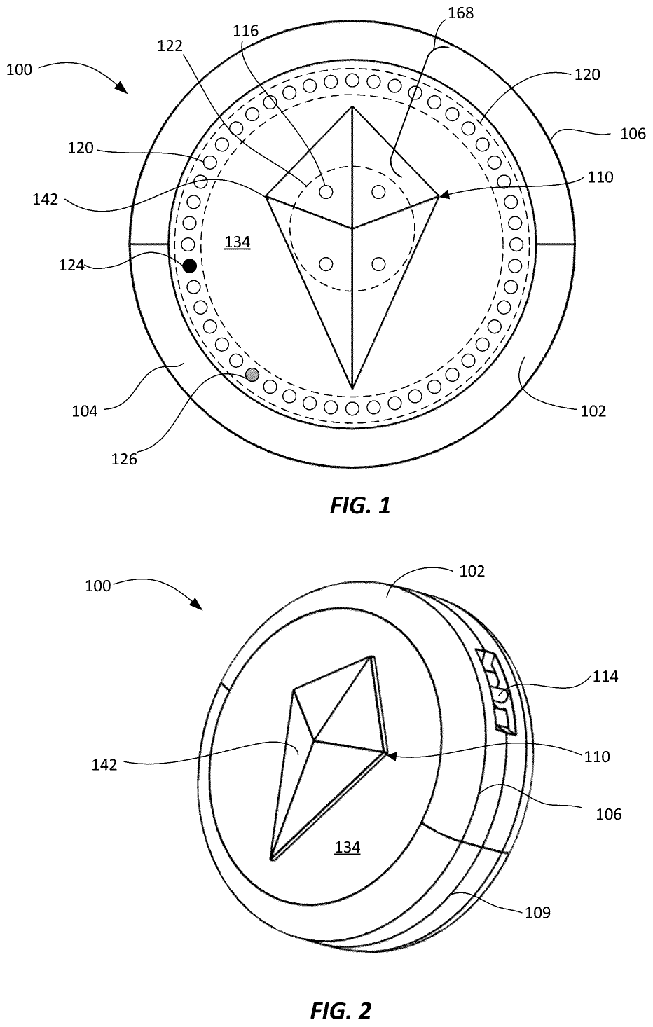

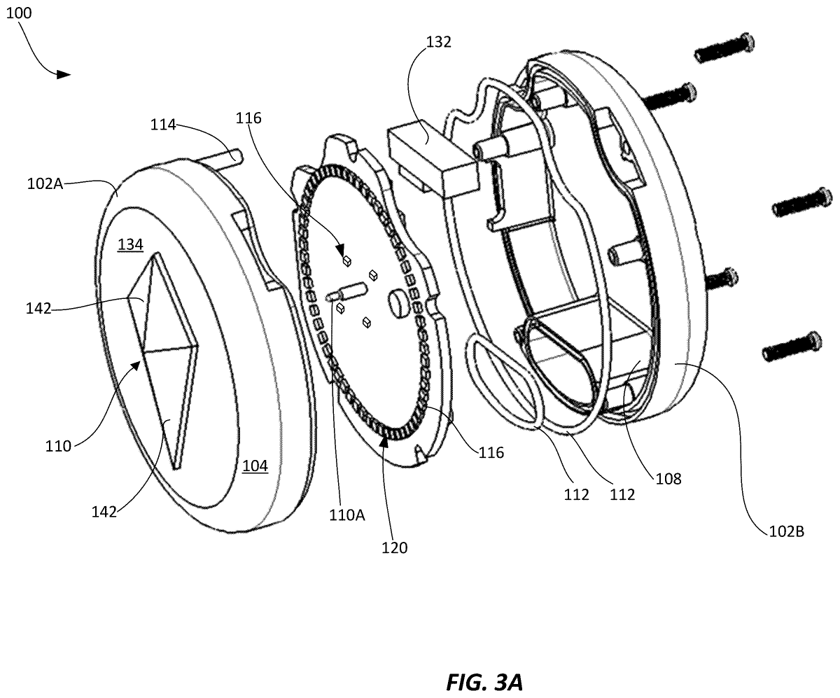

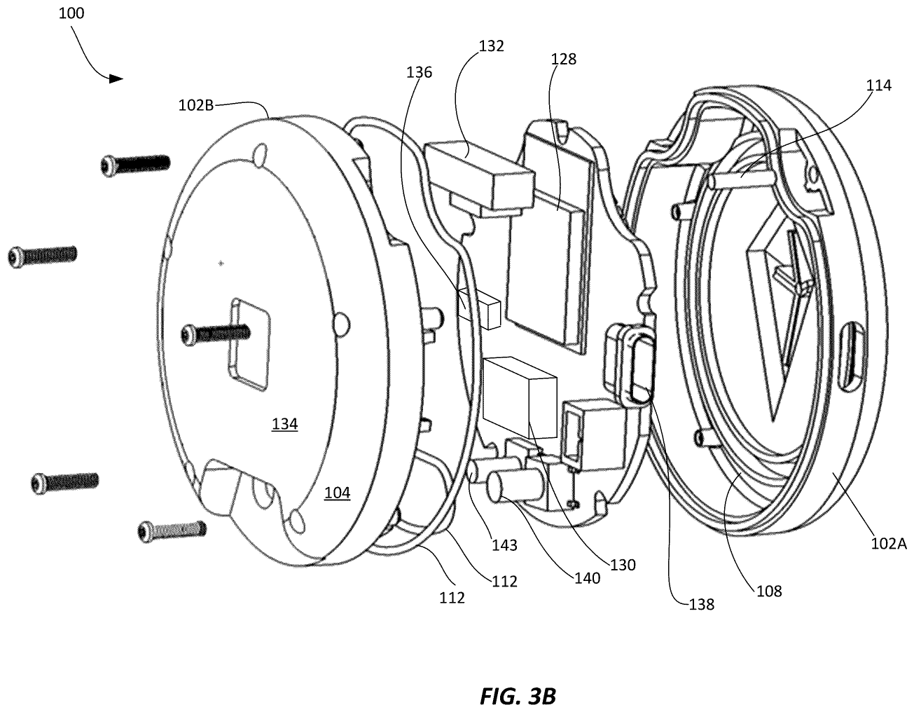

Referring now to the drawings in which like reference characters designate like or corresponding characters throughout the several views, there is shown in FIG. 1, FIG. 2, FIG. 3A, and FIG. 3B, one locator device 100 of a system having at least a pair of locator devices that are each configured to provide an illuminated display indicating a location of another locator device (i.e., a second locator device) relative to the first locator device according to an embodiment of the present invention. In the illustrated embodiment, the locator device 100 includes a case 102 with an exterior 104, a perimeter 106, a front surface 134, and an interior cavity 108. The case 102 is preferably transparent or at least translucent. In certain embodiments, the case 102 includes a first half 102A and a second half 102B, which may be separable from each other by a joint 109, such as a joint extending along the perimeter 106.

A user interface 110 is also disposed on the exterior 104 of the case 102 and is configured to receive user inputs. Preferably, when the locator devices 100 are powered on, all commands for controlling the locator device are provided to the locator device via the user interface 110 and capacitive touch sensor 110A, including a pairing input for placing the locator devices into pair mode. Pairing in this manner allows the devices to operate without the need for an accompanying phone or computer-based application (app). In certain embodiments, the front surface 134 of the locator device 100 includes a plurality of raised facets 142. Although four facets 142 are illustrated, other numbers of facets are contemplated. In certain cases, the user interface 110 is operated via a capacitive touch sensor 110A (FIG. 3A) that is located underneath and is activated by physical contact with the facets 142. In certain embodiments, the capacitive touch sensor 110A may comprise a spring-loaded contact, i.e., a pogo pin. In other embodiments, the capacitive touch sensor 110A may comprise a touch spring or an external contact. However, in other embodiments, one or more of the facets 142 may include physical buttons and act as a user interface 110.

In certain embodiments, a gasket set 112 may be disposed between the first half 102A and the second half 102B. The gasket set 112 preferably seals the locator device 100 from particulate (e.g., dust) and liquid intrusion, thereby providing a locator device 100 that is substantially dustproof and waterproof. For example, the locator device may be rated with an ingress protection rating of IP5X or IP6X. Further, in certain embodiments, sealing the first half 102A and the second half 102B can seal a volume of air in the interior cavity 108 to provide a buoyant locator device 100. Alternatively, the gasket set 112 may directly contact the internal componentry of the locator device 100 at potential points of contaminant intrusion.

The locator device 100 may further include an attachment point 114 or a pair of attachment points. These attachment points 114 may cooperate with a corresponding lanyard, wristband, glove, clip, or other device, making the locator device 100 portable and allowing the locator device to be worn by a user.

The locator device 100 also include various visual indicators that, in preferred embodiments, allow the locator device to function either as a compass or in a “vibe mode” that is responsive to, among other things, sound waves or vibration. In particular, a plurality of first visual indicators 116, which may be lights such as LED lights, is located in a central region 122 of the case 102. In preferred embodiments, the first visual indicators 116 are confined within the central region 122 of the case 102 such that a space 168 that lacks first visual indictors extends from the outside of the central region to the perimeter 106 of the case. Next, a plurality of second visual indicators 120, which may also be lights such as LED lights, preferably forms a single ring that is located in the space 168 and may be positioned near the perimeter 106 of the case 102. In preferred embodiments, the second visual indicators 120 form a continuous ring. In certain other embodiments, the case 102 is translucent but slightly opaque. This means any light emanating from within the case 102 appears partially diffused at the exterior 104. In these embodiments, the second visual indicators 120 appear to form a continuous ring from the exterior 104, but are, in fact, individual visual indicators arranged in a circle. Preferably, both the first visual indicators 116 and the second visual indicators 120 are configured to selectively change from a first illumination state to a second illumination state. Further, when illuminated, the visual indicators 116, 120 are observable to an observer that is observing the front surface 134 of the case 102. For example, the visual indicators 116, 120 may be disposed on the exterior 104 of the case 102 or may be positioned within the interior cavity 108 (and observable through the case). In certain embodiments, the facets 142 of the front surface 134 of the case 102 corresponds to a first visual indicator 116 of the second plurality of visual indicators such that only one visual indicator is observable through each facet. In certain embodiments, the second visual indicators 120 may be so tightly spaced that, if all were in the illuminated state, a visually unbroken circle would appear.

In certain embodiments, each visual indicator 116, 120 is a light providing a variable illumination state depending on the position of the locator devices relative to one another. The variable illumination state may include a steady illuminated state, a pulsing illuminated state, and a steady unilluminated state. In other embodiments, the visual indicators 116, 120 can display various colors. In some cases, the variable illumination state is a variable brightness level. In some cases, the brightness of the lights may be configured to vary as a distance between the pair of locator devices increases and decreases. In some cases, when paired locator devices 100 are initially separated by a distance that is less than a pre-defined maximum separation distance and are then separated by a distance that is greater than the pre-defined maximum separation distance, a selected first visual indicator remains in the second illumination state (e.g. steady illuminated state or pulsing illuminated state) so as to indicate a last known position of the other one of the pair of locator devices. Preferably, an illumination status of the selected first visual indicator corresponding to the other one of the pair of locator devices 100 is updated from the last known position only after the pair or locator devices are within the pre-defied maximum separation distance.

In certain embodiments, the visual indicators 116, 120 may be lasers projected from the interior cavity 108 and observable from the exterior 104. Because of the transparent or translucent nature of the case 102, visual indicators 116, 120 disposed within the case are observable from the exterior 104 when lit. For illustrative purposes, in FIG. 1, visual indicators 116, 120 are shown as hollow circles to represent a first illumination state (e.g., a steady unilluminated state), dark solid circles 124 to represent a second illumination state (e.g., steady illuminated state, a pulsing illuminated state), or lightly filled circles 126 to represent a third illumination state (e.g., lower/higher brightness level). Utilizing visual indicators 116, 120, allow for the locator devices 100 to be devoid of any screens.

Disposed within the interior cavity 108 is a controller 128, such as a microcontroller, which is configured to control at least certain operations of the locator device 100. For example, among other things, the controller 128 is preferably configured to change the visual indicators 116, 120 from the first illumination state to the second illumination state. Preferably, the controller 128 is configured to change the illumination states of the visual indicators 116, 120 in response to receiving location information identifying a position of one or more of the paired locator devices 100. For example, in certain embodiments, the controller 128 is configured to selectively change the visual indicators 116 between the first illumination state and the second illumination state in response to receiving location information indicating that the second one of the pair of locator devices is or is not within a first range relative to the first one of the pair of locator devices (e.g., 10′ (ten feet)). Additionally, the controller 128 is also preferably configured to selectively change visual indicators 120 between the first illumination state and the second illumination state in response to receiving location information indicating that the second locator device is or is not within a second and different range relative to the first one of the pair of locator devices (e.g., more than 10′ (ten feet) and less than 3300′ (three thousand three hundred feet)). In certain cases, including the case mentioned above, the first range and second range do not overlap with one another. However, in other cases, the ranges do overlap. Additionally, other ranges may be associated with different functions or response from the locator devices 100.

In one example illustrating the functionality described above, suppose a pair of friends are separated by 2000′ (two thousand feet) at a music festival (Position A) and each is provided with one of a pair of locator devices that have been paired to one another. On each friend's device, in response to the controller 128 receiving location information that the devices are separated by 2000′ (two thousand feet), one of the visual indicators 120 of each device that is located in the direction headed towards the other changes from being unilluminated (i.e., a first illumination state) to being illuminated (i.e., a second illumination state).

On one hand, as the friends walk towards one another, the location of the illuminated light is preferably continuously updated to move around the ring of light to be located at the location that is most near the direction headed towards the other locator device. By providing visual indicators 120 in a continuous ring, a very precise direction can be provided. Eventually, the friends are close enough (e.g., 10′ (ten feet), 20′ (twenty feet), or 30′ (thirty feet), Position B) that the luminated visual indicator 120 is unilluminated and one of the unilluminated indicators 116 is illuminated to indicate that the friends are nearby one another. As before, as the friends walk towards one another, the location of the illuminated light is preferably continuously updated to move to be located at the location that is most near the direction headed towards the other locator device.

On the other hand, if the friends were to walk away from each other while at Position A to a distance more than the second range (e.g., 5000′ (five thousand feet), Position C), the illuminated visual indicator 120 (i.e., the light in the ring of lights) might remain illuminated to indicate a direction of last known position. When in this mode, the light might dim to a low or minimum brightness level, or it may pulse to show that the locator devices are out of range and to save battery life.

In certain embodiments, the controller 128 is configured to work cooperatively with a positioning system, such as the global navigation satellite system (GNSS), to determine the location of one locator device 100 relative to other locator devices. Advantageously, by utilizing GNSS or another positioning system, the controller 128 does not rely on cellular devices or service to determine the location of the locator device 100, meaning the locator device can function in areas and situations devoid of cellular service. The controller 128 may also utilize short-range communication, such as Bluetooth, Near Field Communication (NFC), or the ESP-Now communication protocol, to communicate with other locator devices or to enable other capabilities, such as contactless payment or access control. Such capabilities would require and, therefore, the locator devices 100 may be provided with the appropriate receivers, radios, etc. (not shown) that are known to those of skill in the art to enable such functionality. In certain embodiments, a networking device, or series of networking devices, i.e., a beacon or numerous beacons, may be provided as an alternative to utilizing GNSS for positioning data. For example, if the locator devices 100 are inside a building or under a roof, cooperating with the GNSS may be impracticable but a beacon could be utilized to enable the locating functionality of the locator devices. To indicate communication or pending communication with the positioning systems, the visual indicators 116, 120 may cycle though the first, second, or third illumination states in a specific pattern. In certain embodiments, the controller 128 may communicate with a phone-app or an internet signal via wi-fi. This allows the locator device 100 and the various associated componentry and the underlying software to be updated periodically, as required.

In certain embodiments, the locator devices 100 also include an orientation sensor 132 for detecting an orientation of the device in space. In certain embodiments, the orientation sensor is an inertial measurement unit (IMU), which may be disposed within the interior cavity 108 of the locator device 100. The orientation sensor 132 is configured to determine a physical orientation of the locator device 100, i.e., flat, tilted, upside-down, etc. with respect to a ground surface, and to communicate orientation signals to the controller 128 that are based on the orientation of the locator device. The orientation sensor 132 is preferably a 9-axis IMU and includes an accelerometer, gyroscope, and magnetometer. Preferably, the orientation sensor 132 utilizes automatic calibration which re-calibrates every time a user completes a full 360-degree turn (purposefully or not). This allows the orientation sensor 132 to use magnetism to determine orientation and, partially, bearing, without requiring a user to recalibrate if the orientation sensor is disrupted by a nearby magnetic field. The controller 128 is further configured to utilize the positional data from the orientation sensor 132 to enable certain modes of operation. In certain embodiments, in a first mode, the locator device 100 is configured to locate and display the location of the second locator device.

In a second mode of operation (e.g., “vibe” mode), visual indicators 116, 120, are configured to alternate between illumination states based on an external input. For example, the locator device 100 may further comprise a microphone and the external input may be an auditory input, such as music or speech. In other embodiments, the external input may be vibrational or impact-based and be detected by the orientation sensor 132. The response of the visual indicators 116, 120 may depend on the volume of the auditory input or the intensity of the vibration or impact. For example, at a low volume, a small number of visual indicators may be illuminated in a certain color range (e.g., blue). On the other hand, at a higher volume, a greater number of lights may be illuminated in a different color range (e.g., red).

In certain embodiments, the user interface 110 may be used as a mode selector for switching the locator device 100 between various modes of operation, including between the first mode and second mode. In other embodiments, changes in the physical orientation of the locator device 100 may be used to automatically switch the mode of operation of the locator devices 100. In such cases, the physical orientation of the locator device 100 might be measured by the orientation sensor 132 and the mode may be selected based on an angular position of the locator device. For example, the locator device 100 might be placed in a first mode of operation (e.g., vibe mode) when the front surface 134 faces directly away from the wearer's chest (i.e., horizontally, or parallel with the ground surface), which is defined as 0°. The locator device 100 preferably remains in this mode through some angular range before being automatically switched to the second mode of operation (e.g., compass mode). For example, in certain embodiments, the locator device 100 preferably remains in vibe mode until approximately 45° with respect to the ground surface. This might occur, for example, if a locator device 100 is secured via a lanyard around a wearer's neck, is initially resting against the wearer's chest, and is then tilted partially upwards away from the wearer's chest about the lanyard connection. Once the locator device has been angled approximately halfway between being oriented vertically (e.g., when hanging from the lanyard) and oriented horizontally where the front surface of the locator device points upwards (i.e., 90°), the mode preferably switches from “vibe” mode to “compass” mode. In certain embodiments, the locator device 100 may remain in that second mode from approximately 45° until about 180° (i.e., where the front of the locator device is facing the wearer's chest). Thus, advantageously, the front surface of the locator device faces outwards when the visual indicators 116, 120 are reactive to external input and then faces upwards or towards the wearer's face when being used in compass mode. Another advantage of the present design is that the mode selection occurs automatically without requiring the wearer to press any button or contact the user interface 110 on the locator device 100.

Preferably, in the first mode of operation, the controller 128 and the orientation sensor 132 work in conjunction to ensure the location of the second locator device is accurately displayed, regardless of the orientation of the locator device 100 with respect to the ground. In certain further embodiments a vibration motor 136 is disposed within the interior cavity 108 and is configured to provide haptic feedback to a user of the locator device 100.

Next, a power source 130 provides power to the visual indicators 116, 120, and to the controller 128. In certain embodiments, the power source 130 is a rechargeable battery and the locator device 100 includes an externally-accessible charging port 138. The charging port 138 may be weatherproof to preserve the waterproof and dustproof nature of the locator device 100. Optionally, charging may be wireless. In certain embodiments, a power button 140 is accessible from the exterior 104 to turn the locator device 100 on and off. The power button 140 may also be used to place the locator device 100 in various power modes. For example, pressing the power button 140 a specified number of times may place the locator device 100 in a full-power mode, where all operational modes are activated, and the locator device remains in constant communication with the positioning system. Pressing the power button a different number of times may place the locator device 100 in a low-power or “Eco” mode wherein certain operational modes, such as “vibe mode” are deactivated or provided less power and the locator device communicates less frequently with the positioning system. The Low power mode may also be activated if the power source 130 reaches a diminished level of capacity, e.g., a 20% battery charge. The power button 140 may be the only physical button disposed on the locator device 100.

In certain embodiments, an emergency button 143 may be provided whereby, if pressed, an alert is sent to the other paired locator devices 100. If no emergency button 143 is present, an alert may be sent utilizing the user interface 110. Preferably, the alert will persist even if the originating locator device 100 loses power. In this case, the locator devices 100 still with power will display the alert and the last known location of the now unpowered locator device. In certain embodiments, the alert may be sent to all nearby devices 100 but in other preferred embodiments, the alert will only be sent to paired or bonded devices.

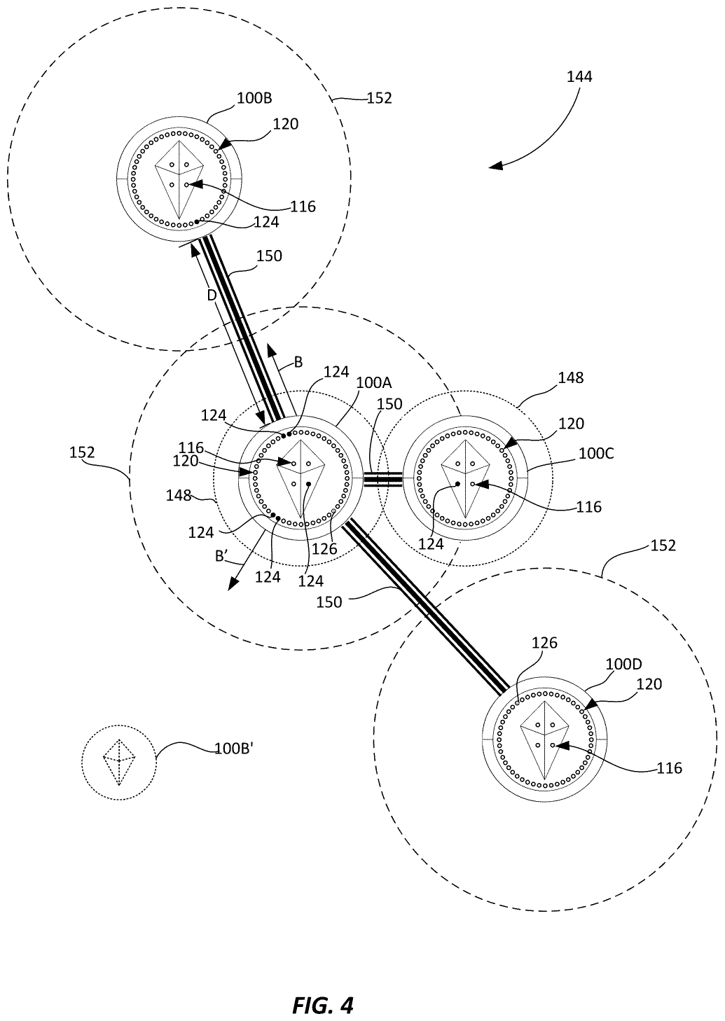

Now with reference to FIG. 4, a system 144 according to an embodiment of the present invention is shown and includes several locator devices 100 (identified here as 100A, 100B, 100C, 100D). The “location” of each locator device 100 is preferably defined by a distance D and a heading B. To indicate the distance D, when the second locator device 100B is within a first range 148, at least one visual indicator 116 preferably changes from one illumination state (e.g., steady unilluminated) to another illumination state (e.g., steady illuminated). When the second locator device 100B is within a second range 152, at least one visual indicator 120 preferably changes from one illumination state (e.g., steady unilluminated) to another illumination state (e.g., steady illuminated). In certain embodiments, locator devices 100 must be “paired” or share “bonds” 150 in order to display the other's location. Importantly, numerous locator devices 100 can be in operative communication without sharing bonds 150, meaning the devices can communicate without displaying the location of the other devices. Preferably, any bonds 150 are preserved within the system 14, even if one of the several locator devices 100A, 100B, 100C, 100D, loses power or temporarily loses connection to the other devices.

In certain embodiments, the illumination state of visual indicators 116, 120 depend on the heading B of the second locator device relative to the first locator device 100. For example, the heading B of a first locator device 100A relative to a second locator device 100B might be indicated by illuminating a visual indicator 116, 120 of the second locator device in a position that indicates the heading of the first device relative to the second device. As the heading of the first locator device 100 changes to a new heading B′ with respect to the second locator device (or vice-versa), new visual indicators 116, 120 are updated to reflect the new heading (demonstrated by relocated second locator device 100B′). For example, a northernly-positioned visual indicator 116 might be initially illuminated to indicate that the second locator device 100B is located north of a first locator device 100A. Later, as the second locator device 100B travels eastwards, the northernly-positioned visual indicator 116 might be unilluminated and a north-easternly visual indictor might be illuminated to indicate the updated position of the second locator device relative to the first locator device 100A.

The first distance range 148 is preferably smaller than the second distance range 152. Other, additional distance ranges may be present and correspond to other functionality of the locator device 100. Preferably, the first range 148 is between 1′ and 10″ (one foot and ten feet) but can be up to 30′ (thirty feet). The second range 152 begins where the first range 148 ends and is up to 1200′ (one thousand two hundred feet). In certain embodiments, the un-extended second range 152 is up to 1500′ (one thousand five hundred feet), 1750′ (one thousand seven hundred fifty feet), 2000′ (two thousand feet), or 3300′ (three thousand three hundred feet). As before, when the third locator device 100C, which is also bonded 150 with the first locator device 100, is within the second range 152 of the first locator device 100A, the illumination state of one or more visual indicators 120 associated with either locator device might change to reflect their respective locations. In certain embodiments, visual indicators 116, 120 are capable of displaying colors, and a specific color may be exclusively associated with each locator device across all indictors. In these embodiments, placing the bonded locator devices, such as locators 100A and 100B in physical contact or within a small distance, such as 1″ (one inch), causes the visual indicators 116 on both devices to display the specifically associated color. As an alternative to physical contact or extreme proximity, the display of the specific color may be conditioned on a communication strength between two locator devices 100A, 100B. For example, if the received signal strength indicator (RSSI) between the two devices is above a certain level, e.g., RSSI is greater than −20 or −15 or −12, the associated color is displayed on the visual indicators 116 of both locator devices 100A, 100B.

In certain preferred embodiments, visual indicators 116, 120 have a variable brightness level that changes as the distance D between the locator devices 100 changes. For example, as the first and second locator devices 100A, 100B are just within the second range 152, the visual indicator 120 may have a diminished brightness, such as visual indicator 126. As the distance D between the first and second locator devices 100, 100B, decreases, meaning the devices are closer together, the brightness of the observable visual indicator 120 may increase. The maximum brightness level, such as that shown by visual indicator 124, is reached as the first and second locator devices 100, 100B are adjacent, but not within, the first range 148. In certain other embodiments, as an alternative to varying a brightness level of the visual indicator 120 to represent the distance D between the locator devices 100, additional, adjacent visual indicators may become illuminated to indicate closeness with the other locator device. For example. When the first and second locator devices 100A, 100B are beyond 300′ (three hundred feet) apart, a single visual indicator 120 is illuminated, but as the separation distance decreases to less than 300′ (three hundred feet) apart, the immediately adjacent visual indicators are illuminated (for a total of 3 illuminated visual indicators). Additional visual indicators 120 can be added at various separation distances, for example, between 300′ and 180′ (three hundred feet and one hundred and eighty feet, respectively) three adjacent visual indicators may be illuminated, between 180′ and 120′ (one hundred and eighty feet and one hundred and twenty feet, respectively) five adjacent visual indicators may be illuminated. Between 120′ and 30′ (one hundred and twenty feet and thirty feet, respectively), seven adjacent visual indicators 120 may be illuminated. At less than 30′ (thirty feet) of separation, one of the first visual indicators 116 illuminates. The specified distances are given as examples and not intended to limit the invention described herein. Other distances and ranges are contemplated. Additionally, the distances may adjust based on signal strength and the accuracy of the calculable location if each locator device. In certain embodiments, an algorithm may be employed to calculate the appropriate distance to illuminate the first visual indicator 116.

In certain embodiments, a visual indicator having a diminished brightness 126 may represent the last-known location of a locator device bonded to the first locator device 100 but outside of the first range 148. For example, a fourth locator device 100D may share a bond 150 with the first locator device 100A. As locator devices 100A, 100D, are within the second range 152, each respective device displays the directional heading B of the other device by changing the illumination state of visual indicators 120 (e.g., the visual indicators are illuminated, pulse, are unilluminated, increase in brightness, etc.). As locator devices 100A, 100D move outside of the second range 152, the visual indicator 120 representing the directional heading B of each device prior to the devices being out of range might be reduced to a minimum brightness level 126, where it remains until the devices are back within range of one another. When back in range, the brightness level increases and the visual indicator 120 representing the directional heading B updates to reflect the current directional heading. In certain other embodiments, visual indicator 126 may change colors or pulse to represent the last-known location of an out-of-range locator device 100. In certain embodiments, the visual indicators 116, 120, may change in brightness or color to indicate a low battery. Further, the locator devices 100 may include a brightness sensor and the illumination level may reduce or increase based on the ambient light conditions.

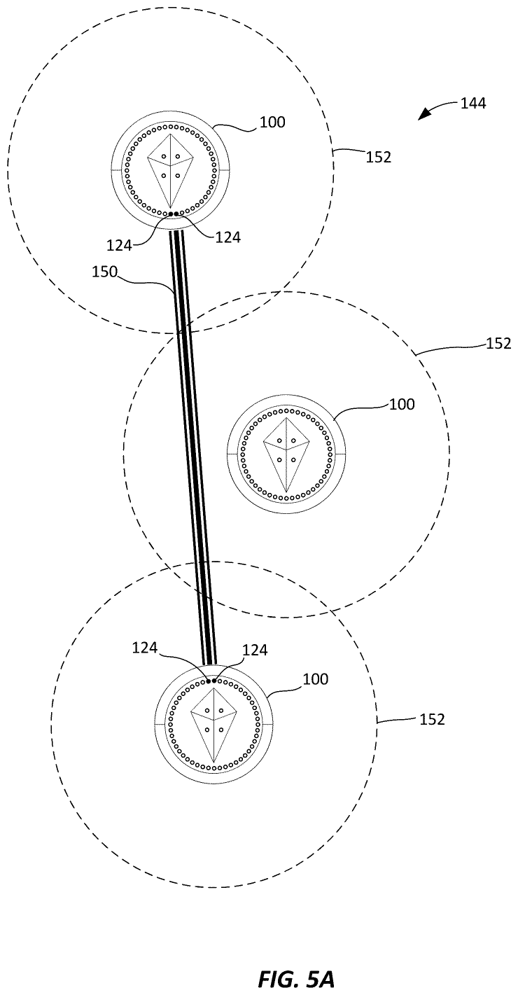

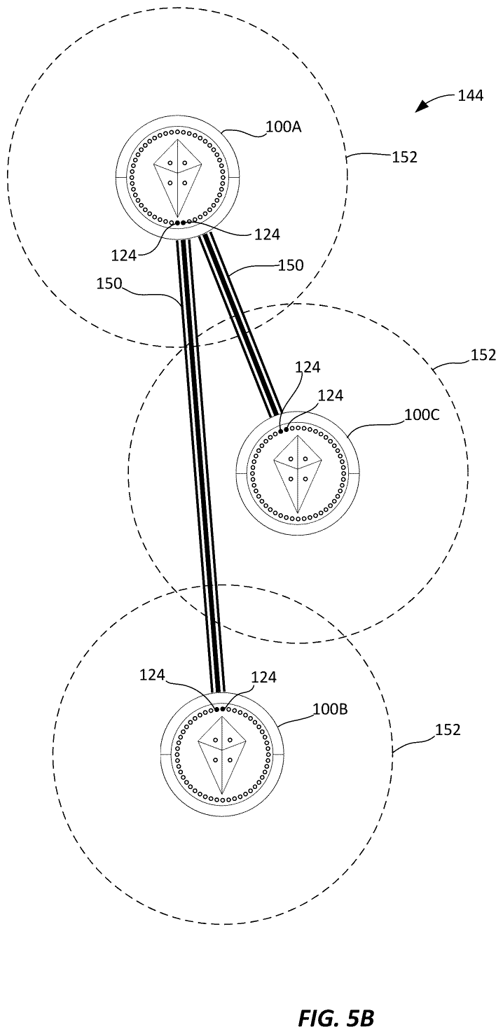

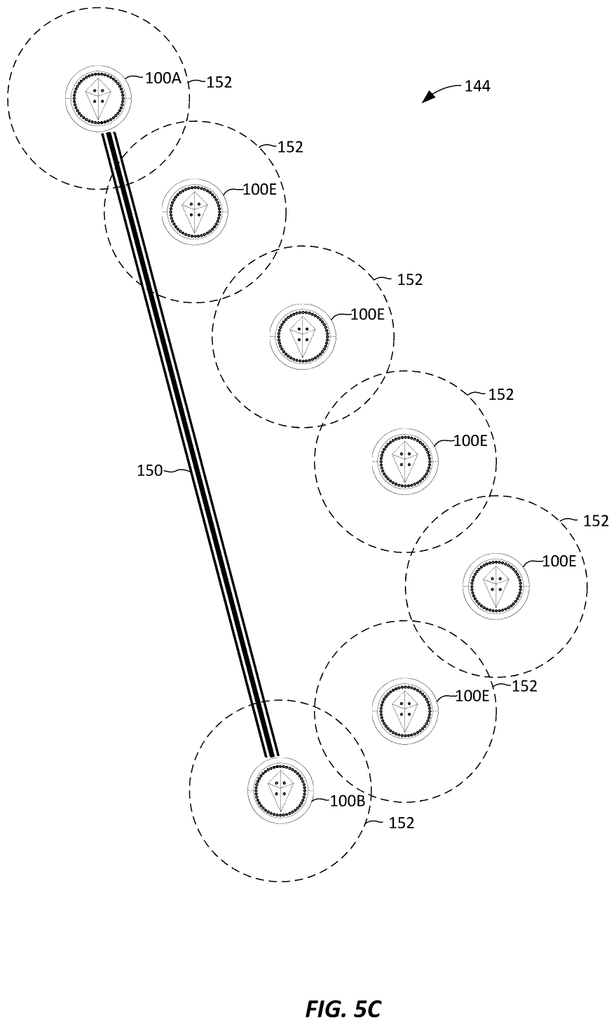

As shown in FIG. 5A, in certain embodiments, locator devices (e.g., third locator device 100C) may act as network bridge devices that provide communication between two bonded devices (e.g., first locator device 100A and second locator device 100B) that would otherwise not be in communication with one another since the first and second locator devices are not within range 152 of each other but third locator device 100C is within range of both. As the distance between the first and second locator devices 100A, 100B, extends beyond the second range 152, absent a network bridge device, each locator device displays the last known location of the other device at a diminished brightness level (as explained above). If the third locator device 100C, acting as a network bridge, is within the second range 152 of the first and second locator devices 100A, 100B, the effective range of the locator devices is extended. This results in the location of the first and second locator devices 100A, 100B being updated in real-time on the other respective device, as opposed to only a last-known location being displayed. In this embodiment, and in other embodiments, the third locator device 100C is in operative communication with the first and second locator devices 100A, 100B, but is not bonded 150 to either device, such that the third locator device does not display the location of the other two bonded devices; instead, the third locator device simply acts as a “repeater” or “bridge.” While locator devices 100 are used for this bridging function in the illustrated embodiment, other signal repeaters that are not locator devices may also be used for the same purpose.

However, in certain embodiments and as illustrated in FIG. 5B, the third locator device 100C may be bonded 150 to either or both of the first and second locator devices 100A, 100B. In certain embodiments, the bonding 150 has no effect on the range-extending capability of any device bridging the two or more locator devices. Further, as shown in FIG. 5C, a network bridge may be formed by a plurality of locator devices 100E, all being within the second range 152 of at least one adjacent locator device, where at least one is in the second range of the first locator device 100A and one is within the first range of the second locator device 100B. In other words, the more devices 100 in an area, the stronger the network (or mesh) created by the operative communication. In certain embodiments, a user, using the first locator device 100 may send an auditory message to the second locator device if the devices are bonded 150 and if the devices further include. In certain embodiments, a message may be sent from the first locator device 100 to another locator device utilizing visual indicators 116, 120.

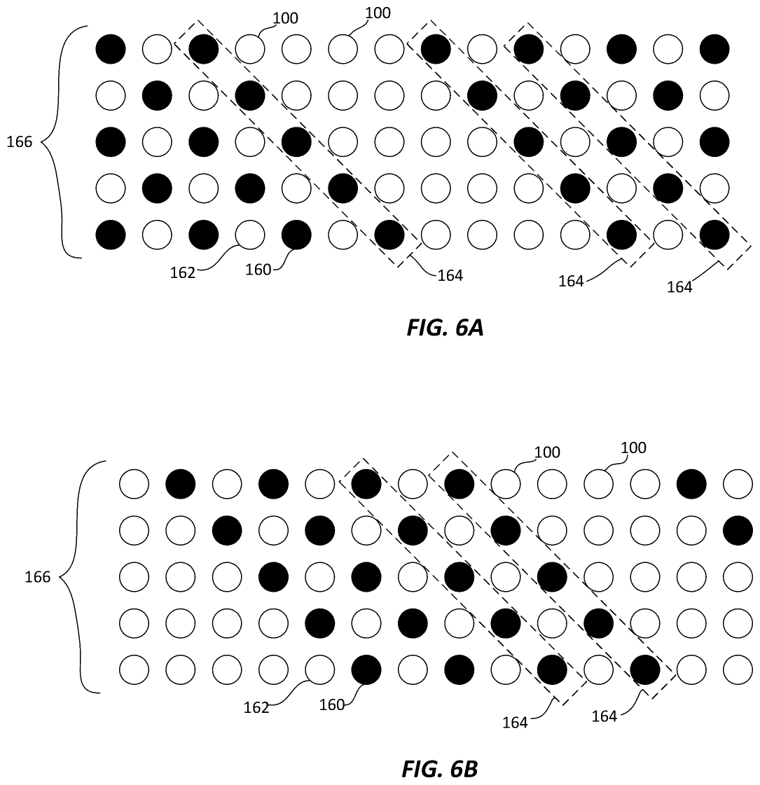

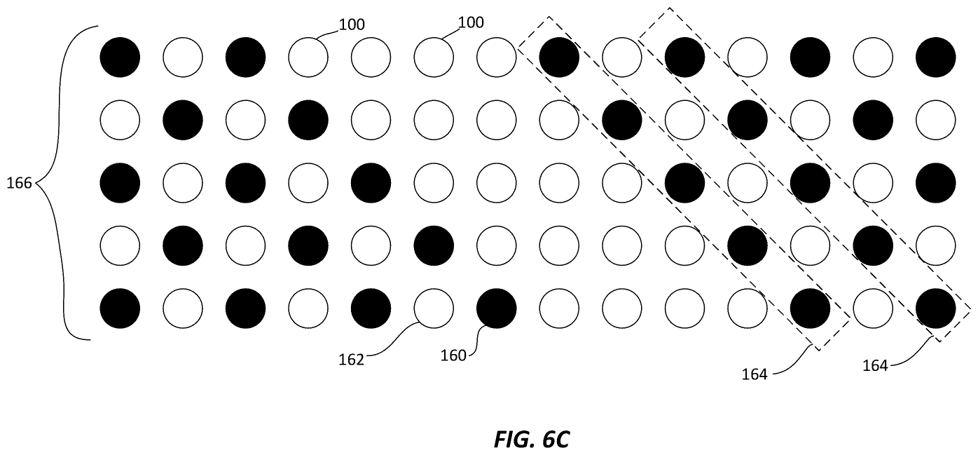

With reference now to FIGS. 6A-6C, as mentioned earlier, multiple locator devices 100 may be in operative communication without displaying the location of the other, nearby devices. This operative communication creates a local mesh network and allows multiple locator devices 100, preferably in the second mode of operation, to cooperate and create cohesive, static, or dynamic displays. For example, utilizing the first and second plurality of visual indicators, certain locator devices 100 may be illuminated 160 or unilluminated 162 to create a pattern, such as lines 164 or other patterns propagating across the group 166 of locator devices. Other displays may include color or brightness patterns. In certain embodiments, the locator devices 100 utilize an external input, such as sound to determine and regulate the display. In certain embodiments, the group 166, meaning all locator devices 100 within a designated area or operatively connected, may be configured to receive a specific communication, such as an emergency communication. In addition, in certain embodiments, the location of each operatively connected locator device 100 within a group 166 may be tracked, recorded, and aggregated by a central command center. This same command center is what is used to send a specific communication or used to update the software of the locator devices 100. In certain embodiments, one locator device 100 may act as a remote command center to initiate a software or firmware update on all nearby devices. For instance, a one locator device 100 may connect to Wi-Fi internet network using a unique network credential. This locator device 100 can then initiate an update on all nearby devices (in this instance, “nearby” means devices in extreme proximity or physical contact with the others). The proximity can also be determined by the RSSI. In certain embodiments, the update process comprises a secure sharing of the unique network credential between all nearby locator devices 100, meaning each locator device will connect to the Wi-Fi independently via the same credential. In some embodiments, the network credential accesses a private Wi-Fi network, such as a home network, whereas in other embodiments the network credential accesses a public Wi-Fi network, such as one managed by the central command center.

Referring once again to FIGS. 1-4, also disclosed herein is a method for a first peer to track and locate a second peer. The method comprises a first step of providing a system 144 (described above) for locating and tracking a peer. According to this method, a pair of locator devices 100 are placed into operative communication with each other by being powered on, such as by using power button 140. Communication between the locator devices 100 is facilitated by the controller 128 and its connection with the Global Navigation Satellite System. In certain embodiments, as the locator devices 100 are powered on, the visual indicators 120 indicate a power level of the device. Additionally, the visual indicators 116 may display a color to indicate a current firmware or software version of the locator device 100. In certain embodiments, multiple locator devices 100 are also placed in operative communication with the first and second locator devices. In some embodiments, after a locator device 100 is powered on but before it is placed in operative communication with other locator devices, the visual indicator 120 indicating a northward direction illuminates. In other words, the locator device 100 acts as a directional compass. Once the locator device 100 operatively communicates with other locator devices, the “northern light” deluminates. Next, the locator devices are preferably held in close proximity to the other while each respective peer or user holds the user interface 110. In certain embodiments, close proximity may be as small as having the devices 100 touching or as spaced as 2 feet or further. Ideally, the close proximity is between 2″ and 6″. This pairing process produces a bond 150 between the locator devices 100, which enables each to display the location of the other locator device. The same steps may be used to bond or pair multiple locator devices 100 to other locator devices. However, the locator devices 100 do not necessarily share common bonds 150. Importantly, the locator devices 100 are not pre-paired and utilize a connectionless communication protocol to establish bonds. For example, a first locator device 100 may be bonded 150 to the second locator device 100B and the fourth locator device 100D; the second locator device may be additionally bonded to the third locator device 100C; and the third locator device may be additionally bonded to the fourth locator device. Bonds 150 can be established and severed without effecting pre-existing bonds, up to a maximum number of bonds. Additionally, in certain embodiments, establishing a bond 150 requires inputs from each locator device 100 meaning the location of a specific locator device cannot be erroneously or unknowingly displayed on another locator device. The maximum number of bonds 150 is preferably 4 (four) per locator device 100, but other maximum numbers are contemplated. For example, any number in the range of 1-20 bonds or greater may be created. In certain embodiments, the individual visual indictors 116, 120 are configured to display a color and each locator device bonded 150 with the first locator device 100 is associated with a unique color.

After being configured to display the location of the other locator devices, if the first and second locator devices 100A, 100B are separated from each other by a distance that is within the second range 152, the location of the of the other device is displayed on each. This is accomplished by a visual indicator 120 of the changing from one illumination state (e.g., unilluminated) to another illumination state (e.g., illuminated). For each locator device, the specific visual indicator 120 that changes is positioned at a location corresponding to a directional heading B of the other paired locator device(s). As described above, this position preferably updates in real time as the locator devices 100 change position with respect to one another. Next, if first or second locator device 100A, 100B, is moved towards the other, each device enters into a first range 148 with respect to the other device. The first range 148 is smaller than the second range 152. As the first and second locator devices 100A, 100B, enter into the first range 148, the illumination state of visual indicators 120 are updated (e.g., unilluminated). Preferably, simultaneously, the illumination state of visual indicators 116 are also updated (e.g., illuminated) and remain in that updated state as long as the first and second locator devices 100A, 100B, remain in the first range 148. In embodiments where each locator device 100 is associated with a unique color, the visual indicators 116, 120 also display the same unique and corresponding color.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A locator device system comprising:
a pair of locator devices, each first one of the pair of locator devices is configured to provide an illuminated display indicating a location of a second one of the pair of locator devices relative to the first one, each locator device comprising:
a case having an exterior that includes a front surface;
a plurality of first visual indicators that are each configured to selectively change from a first illumination state to a second illumination state and, when illuminated, to be observable by observing the front surface of the case;
a controller for selectively changing the plurality of first visual indicators between the first illumination state and the second illumination state in response to receiving location information identifying a position of the second one of the pair of locator devices relative to the first one of the pair of locator devices; and
a user interface disposed on the exterior of the case that is configured to receive user inputs including a pairing input for pairing the pair of locator devices to one another,
wherein, when the pair of locator devices are paired together and in response to receiving location information indicating that the pair of locator devices are at a predefined location relative to one another, the controller changes a selected first visual indicator of the plurality of first visual indicators from the first illumination state to the second illumination state.

2. The system of claim 1 wherein the user interface consists of a capacitive touch sensor, wherein all commands for controlling a powered-on locator device are provided to the locator device via the user interface.

3. The system of claim 1 wherein the plurality of first visual indicators forms a single ring of lights disposed adjacent a perimeter of the case, where each is configured to selectively illuminate and unilluminated, and where the selected first visual indicator changing from the first illuminated state to the second illuminate state is located in a direction corresponding to a direction heading towards the other one of the pair of locator devices.

4. The system of claim 1 wherein the plurality of first visual indicators is confined to within a central region of the case such that a space lacking first visual indictors extends from outside the central region to a perimeter of the case, and where each of the first visual indictors is configured to selectively illuminate and unilluminate.

5. The system of claim 4 further comprising a plurality of second visual indicators that forms a single ring of lights disposed in the space and located adjacent a perimeter of the case, and where each of the plurality of second visual indicators is configured to selectively illuminate and unilluminate.

6. The system of claim 5 wherein:
the controller is configured to selectively change the plurality of first visual indicators between the first illumination state and the second illumination state in response to receiving location information indicating that the second one of the pair of locator devices is or is not within a first range relative to the first one of the pair of locator devices; and
the controller is configured to selectively change the plurality of second visual indicators between the first illumination state and the second illumination state in response to receiving location information indicating that the second one of the pair of locator devices is or is not within a second and different range relative to the first one of the pair of locator devices.

7. The system of claim 6 wherein the second range lies entirely outside of the first range relative to the first one of the pair of locator devices such that the first range does not overlap with the second range.

8. The system of claim 1 wherein the plurality of first visual indicators comprises lights that are each configured to provide a variable illumination state depending on a location of the first one of the pair of locator devices relative to the second one of the pair of locator devices.

9. The system of claim 8 wherein the variable illumination state comprises a number of visual indicators that selectively illuminate, the number varying as a distance between the pair of locator devices increases and decreases.

10. The system of claim 8 wherein the variable illumination state comprises a steady illuminated state, a pulsing illuminated state, and a steady unilluminated state.

11. The system of claim 1 further comprising a plurality of at least three locator devices that includes the pair of locator devices and that are each configured to be paired together and to indicate a direction of the other two of the at least three locator devices via the selected first visual indicator.

12. The system of claim 1 wherein, when the pair of locator devices are first separated by a distance that is less than a pre-defined maximum separation distance and are then separated by a distance that is greater than the pre-defined maximum separation distance, the selected first visual indicator remains in the second illumination state so as to indicate a last known position of the other one of the pair of locator devices, and wherein an illumination status of the selected first visual indicator corresponding to the other one of the pair of locator devices is updated from the last known position only after the pair or locator devices are within the pre-defined maximum separation distance.

13. The system of claim 12 wherein the plurality of first visual indicators comprise lights that are each configured to provide a variable brightness, wherein when the pair of locator devices are separated by a distance that is greater than the pre-defined maximum separation distance, the selected first visual indicator is maintained at a minimum brightness level; and when the pair of locator devices are separated by a distance that is less than the pre-defined maximum separation distance, the selected first visual indicator is maintained at a brightness level other than the minimum brightness level.

14. The system of claim 1:
wherein each of the pair of locator devices further comprises an orientation sensor configured to sense an orientation of the case relative to a ground surface and to communicate orientation signals to the controller that are based on the orientation of the case,
wherein each of the pair of locator devices is configured to:
when the orientation sensor provides a first orientation signal to the controller, operate in a first illuminated mode of operation wherein at least one of the plurality of first or second visual indicators is configured to be illuminated in response to receiving the location information; and
when the orientation sensor provides a second orientation signal to the controller, operate in a second illuminated mode of operation wherein at least one of the plurality of first or second visual indicators is configured to be illuminated in response to an external input.

15. The system of claim 14 wherein the external input is an auditory input.

16. The system of claim 15 wherein, in the second illuminated mode of operation, the at least one of the plurality of first visual indicators that is illuminated is dependent on a volume of the auditory input.

17. The system of claim 14 wherein the orientation sensor is an inertial measurement unit.

18. The system of claim 1 wherein the user interface comprises a plurality of facets disposed on the front surface of the case, wherein each facet corresponds to and covers a separate first visual indicator of the plurality of first visual indicators such that, when illuminated, the separate first visual indicators are each observable through only one of the facets.

19. A method for a first peer to locate and track a position of a second peer, the method comprising:
providing a locator device system comprising a pair of locator devices, each first one of the pair of locator devices configured to provide an illuminated display indicating a location of a second one of the pair of locator devices relative to the first one, and each locator device comprising: a case having an exterior that includes a front surface; a plurality of first visual indicators that are each configured to selectively change from a first illumination state to a second illumination state and, when illuminated, to be observable by observing the front surface of the case; a controller for selectively changing the plurality of first visual indicators between the first illumination state and the second illumination state in response to receiving location information identifying a position of the second one of the pair of locator devices relative to the first one of the pair of locator devices; and a user interface disposed on the exterior of the case;
placing the pair of locator devices into pairing mode by providing an input via the user interface;
while in pairing mode, automatically pairing the pair of locator devices together by placing them within a pairing distance of each other; and
in response to a first one of the pair of locator devices receiving location information indicating that the pair of locator devices are at a predefined location relative to one other, using the controller, changing a selected first visual indicator of the plurality of first visual indicators that is located in a direction corresponding to a direction heading towards the other one of the pair of locator devices from the first illumination state to the second illumination state.

20. A locator device system comprising:
a pair of locator devices, each first one of the pair of locator devices is configured to provide an illuminated display indicating a location of a second one of the pair of locator devices relative to the first one, each locator device comprising:
a case having an exterior that includes a front surface;
a first plurality of lights confined to within a central region of the case such that a space lacking lights extends from outside the central region to a perimeter of the case, where each of the first plurality of lights is configured to selectively change from a first illumination state to a second illumination state and, when illuminated, to be observable by observing the front surface of the case;
a second plurality of lights forming a single ring that is disposed in the space adjacent a perimeter of the case, where each of the second plurality of lights is configured to selectively change from a first illumination state to a second illumination state and, when illuminated, to be observable by observing the front surface of the case;
a controller for selectively changing the first plurality of lights and the second plurality of lights between the first illumination state and the second illumination state in response to receiving location information identifying a position of the second one of the pair of locator devices relative to the first one of the pair of locator devices; and
a user interface that is configured to receive user inputs including pairing input for pairing the pair of locator devices to one another, wherein, when the locator device is powered on, all commands for controlling the locator device are provided to the locator device via the user interface,
wherein the controller is configured to selectively change the first plurality of lights between the first illumination state and the second illumination state in response to receiving location information indicating that the second one of the pair of locator devices is or is not within a first range relative to the first one of the pair of locator devices; and
wherein the controller is configured to selectively change the second plurality of lights between the first illumination state and the second illumination state in response to receiving location information indicating that the second one of the pair of locator devices is or is not within a second and different range relative to the first one of the pair of locator devices.
